(19) United States
(12) Patent Application Publication
(10) Pub. No.: US 2011/0035386 A1
(43) Pub. Date: Feb. 10, 2011

(54) System and Method to Manage and Utilize "Social Dynamic Rating" for Contacts Stored by Mobile Device Users

(76) Inventors: Ipai Terry Hsiao, McLean, VA (US); Ipin Clement Hsiao, Taiwan (CN)

Correspondence Address: WOMBLE CARLYLE SANDRIDGE & RICE, PLLC, ATTN: IP DOCKETING, P.O. BOX 7037, ATLANTA, GA, 30357-0037, US

(21) Appl. No.: 12/852,816

(22) Filed: Aug. 9, 2010

Related U.S. Application Data
(60) Provisional application No. 61/232,120, filed on Aug. 7, 2009.

(51) Int. Cl. G06F 17/30; G06F 15/16

(52) U.S. Cl. 707/750; 709/219; 707/E17.084

(57) ABSTRACT

Various implementations of the disclosure relate to social dynamic ratings for contacts stored at a mobile device. For example, a mobile device may be configured to communicate to a server rating information for the contacts. The rating information may include a frequency of access of a contact by the user at the mobile device and/or explicit ratings provided by the user. The server may use the rating information to generate a social dynamic rating for an entity associated with the contact. The server may communicate the social dynamic rating to the mobile device. The mobile device may display the social dynamic rating whenever the contact is displayed at the mobile device or whenever the user accesses a user interface remote from the mobile device configured to display the contact and/or an entity associated with the contact.

### CROSS-REFERENCE TO RELATED APPLICATIONS

This Application claims priority to U.S. Provisional Patent Application Ser. No. 61/232,120, filed Aug. 7, 2009, which is hereby incorporated by reference herein in its entirety.

### FIELD OF THE INVENTION

The invention relates to managing contacts in a contact database, which may be associated with a mobile device (including cell phone, PDA, etc.) and, more particularly, to assigning and making use of one or more social dynamic ratings assigned to each such contact entity.

### BACKGROUND OF THE INVENTION

Mobile device users store contact information for various persons or entities as a contact in a contact database, or “phone book,” which may reside on the mobile device (e.g., mobile phone, PDA, or other mobile device). Each contact in the contact database typically includes information that may be used to communicate with a person, a business, or other entity. Often, this information uniquely identifies the contact within the contact database. This information typically includes the entity's phone number, but often includes additional information such as the entity's physical address, email address, geocode, text address, web site or other contact information. Any given user may possess hundreds or thousands or more of such contacts.

Users of mobile devices often have no mechanism for evaluating the entity associated with such contact information other than personal experience or non-systematic recommendations of a friend, family member, colleague, business or other entity associated with the user or the entity. Some users may make use of rating agencies (i.e., review aggregators, etc.) such as Zagat (i.e., www.zagat.com) or Yelp (i.e., www.yelp.com).

Ratings provided by rating agencies are generated by a diverse group of people through surveys of each individual person's own experience. Information gathered from the surveys is then aggregated by the rating service to generate an overall assessment of the business or service. Often, the only relationship between one contributor to the rating survey and another contributor is the rating agency itself. A user of the rating agency may have nothing in common with the survey participants, and thus the rating may or may not correlate to the user's own personal experience, tastes, preferences, etc.

Conventional systems also fail to mine data related to user actions or behavior with respect to contact information stored as contacts in mobile devices. For example, a frequency with which contact information is accessed by a user of a mobile device may provide insight into the user's opinion of an entity associated with the contact information. In a particular example, the frequency with which the user calls a phone number (or emails contact information, forwards contact information to another user, and so forth) of an entity such as a restaurant may indicate that the user thinks highly of the restaurant. Such actions can be used to generate an assessment of the restaurant, a person, or another entity, yet conventional systems fail to do so.

Conventional systems also fail to take into account relationships among contact information to generate ratings of an entity that are relevant to a user. For example, a user may be more interested in how other users in their contacts view an entity than how the general public views an entity. Thus, the opinion of the user's contacts (or contact of a contact) may be more relevant than the opinion of a random user yet conventional systems fail to consider contacts when generating ratings of an entity, let alone ratings for an entity in the user's contacts.

Thus, it would be advantageous to have a system and method for users of mobile device to manage contacts based on one or more ratings assigned to each contact from one or more persons related to the user that also possess the same contact.

### SUMMARY OF THE INVENTION

According to various implementations of the invention, a contact management system manages and/or stores contacts possessed by each of the mobile device users. The contact management system gathers and maintains one or more ratings (e.g., score, value, ranking or other indicia) as a so-called “Social Dynamic Rating” or SDR, for each of the contacts to provide users of the contact management system with some information regarding a quality of the entity to which the contact pertains. Individual ratings may be gathered from various users that possess a particular contact and aggregated to provide a social dynamic rating for the contact and the underlying entity. In some implementations, the individual ratings may be gathered only from those users of the contact management system that are related to one another by, for example, sharing each other's contacts (e.g., user A possesses a contact for user B and/or vice versa), to provide the social dynamic rating. The SDR may then be saved and displayed as a field in the contact management system and/or in the user's contact database.

In various implementations of the invention, a user provides a rating of the contact (and hence, the underlying entity). In some implementations of the invention, the rating may include a single score for the entity. This single score may assess an overall quality of the entity, a given user's overall satisfaction with the entity, a given user's willingness to recommend the entity, or some other factor. In some implementations of the invention, the rating may include one or more ratings for each of one or more categories, where the rating for each category assesses some aspect or attribute of the entity. Any category for assessing various aspects or attributes of the entity may be used as would be appreciated. In some implementations of the invention, the rating may include an aggregate rating of the one or more ratings for each of the one or more categories.

In some implementations of the invention, the one or more ratings provided by each of the users are aggregated into the social dynamic rating for the contact. In some implementations of the invention, the social dynamic rating for a particular contact is determined by aggregating the ratings provided by each of the users of the contact management system for the particular contact. In some implementations of the invention, the social dynamic rating for a particular contact is determined by aggregating the ratings provided by a subset of the users of the contact management system for the particular contact. In some implementations of the invention, the social dynamic rating for a particular contact is determined by aggregating the ratings provided by related users of the contact management system for the particular contact. In various implementations, a user is a related user with respect to another user if the user possesses a contact representing the other user. In various implementations, a user is a related user with respect to another user if the users are family members. In various implementations, a user is a related user with respect to another user if the users are friends. In various implementations, a user is a related user with respect to another user if the users are co-workers or colleagues. In various implementations, a user is a related user with respect to another user if the users are in a common social or organizational network. In various implementations, users may designate other users as related users. In some implementations of the invention, multiple levels of related users (i.e., users and their related users as well as each of these related users' related users, etc.) may be considered when aggregating the ratings for the particular contact. In various implementations of the invention, ratings from a subset of the users of the contact management system (as opposed to all the users of the contact management system) are aggregated to form an SDR for a particular user.

In some implementations of the invention, multiple SDRs may be determined, each for different levels of relatedness among users. For example, one SDR may be determined from ratings provided by friends of the user and/or another SDR may be determined from ratings provided by family of the user and/or another SDR may be determined from ratings provided by colleagues of the user, etc.

In some implementations of the invention, a weighting factor may be applied to each of the ratings when the social dynamic rating for a particular contact is determined. In some implementations of the invention, a weighting factor dependant on a time since a last use of the contact by the user may be applied to each of the ratings such that a rating of a less recent use of the contact has less effect on the social dynamic rating for a particular contact than a rating of a more recent use of the contact.

In some implementations of the invention, a weighting factor dependant on a reliability of the user applying the rating to a contact may be applied to each of the ratings such that a rating from a less reliable user has less effect on the social dynamic rating for a particular contact than a rating from a more reliable user. In some implementations of the invention, a reliability of a user may be determined with respect to a particular user (i.e., the particular user assigns a weighting factor to be applied to all the ratings of the user based on the particular user's subjective opinion of the reliability of the user). In some implementations of the invention, a reliability of a user may be determined based on the user's rating of a particular contact in relation to other users' rating of the particular contact or based on the users' ratings of all its contacts in relation to other users' rating of those contacts.

In some implementations of the invention, a weighting factor dependant on a frequency of use by a particular user may be applied to the rating such that a rating of a less frequently used contact has less effect on the social dynamic rating than a rating of a more frequently used contact.

In some implementations of the invention, other weighting factors may be used.

In some implementations of the invention, other information gathered by the system during the process of deriving the rating may be attached to the rating or ratings.

In some implementations of the invention, in addition to having the ability to provide a rating of the contact, the possessors of the same contact can input other information about the contact and/or edit information input by others (i.e., in a Wiki fashion), such as category of the service, specialty of the business, or expertise of an individual. In addition to the rating, various implementations of the invention may then be used to manage specific information about the contact that could be displayed and used by each of the possessors of the same contact.

The foregoing summary has outlined, in general, certain aspects of the invention and is to serve as an aid to better understanding the more complete detailed description, which is to follow. In reference to such detailed description, there is to be a clear understanding that the present invention is not limited to the details described and illustrated herein. Any other advantages or variation of fabrication, use, or application that become apparent or obvious from the detailed description or illustrations should be considered within the scope of the present invention.

In an exemplary implementation of the invention, a user has a meal at a restaurant of which is also represented or added as a contact in the user's contact database. Following the meal the user submits a rating (which may be in the form of a detailed survey) of the particular restaurant to the contact management system via his or her mobile device or other mechanism. The rating is then aggregated with ratings from other users who possess the contact and that have some level of relatedness to the user to determine an SDR. The SDR may then be redistributed to all other related users of the system that possess the contact. In some implementations, appropriate weighting factors may be applied.

In an exemplary implementation of the invention, a user accesses a contact and initiates a telephone call or other communication with an entity. After the call or communication is completed, the user is prompted to provide a rating of the entity to the contact management system. The rating is then aggregated with ratings from other users who possess the contact and that have some level of relatedness to the user to determine an SDR. The SDR may then be redistributed to all other related users of the system that possess the contact. In some implementations, appropriate weighting factors may be applied.

In some embodiments, narrative, written reviews may also be submitted to the system for sharing with other members who have the same contact.

### BRIEF DESCRIPTION OF THE DRAWINGS

FIG. 1 illustrates an exemplary contact management system according to various implementations of the invention.

FIG. 2 illustrates an exemplary process of social dynamic ratings displayed at a mobile device according to various implementations of the invention.

FIG. 3 illustrates an exemplary process of generating social dynamic ratings according to various implementations of the invention.

### DETAILED DESCRIPTION OF THE INVENTION

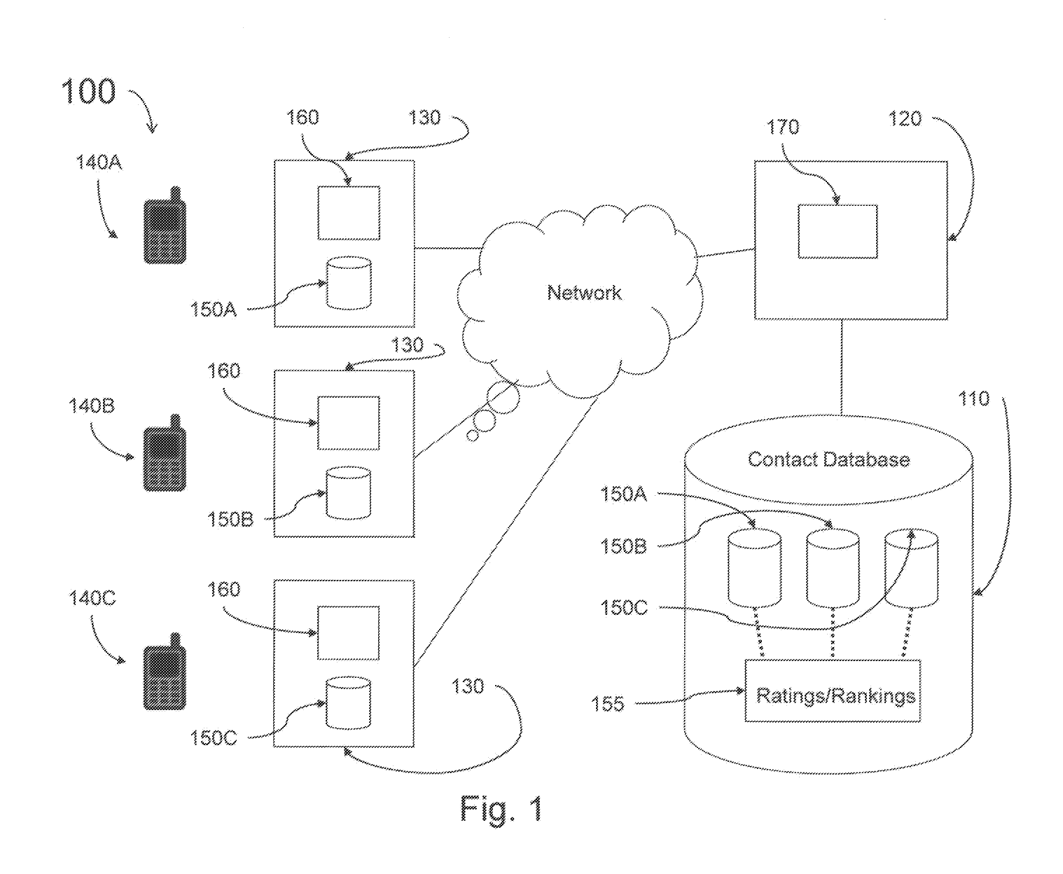

FIG. 1 illustrates an exemplary contact management system 100 according to various implementations of the invention. Contact management system 100 includes a contact database 110, one or more processors 120, and one or more user devices 130 through which a user 140 accesses contact management system 100. In some implementations of the invention, contact database 110 may include a plurality of contacts 150 possessed by each of a plurality of users 140. In some implementations of the invention, contact database 110 may include at least one rating for each of one or more of contacts 150 possessed by each of a plurality of users 140. In some implementations of the invention, contact database 110 may include a plurality of contacts 150 as well as at least one rating for each of the plurality of contacts 150 possessed by each of the plurality of users 140.

According to various implementations of the invention, each user 140 ranks or otherwise provides one or more scores for one or more of its plurality of contacts. In some implementations of the invention, each user 140 provides an overall score for the contact, providing a mechanism by which to rank the contact.

In some implementations of the invention, contact database 110 provides a centralized database for storing contacts possessed by a plurality of users 140. In some implementations of the invention, contact database 110 provides a centralized database for storing ratings of contacts possessed by the plurality of users 140. In some implementations of the invention, contact database 110 provides a centralized database for storing a social dynamic rating for each of a plurality of contacts.

In some implementations of the invention, a client side application 160 is stored on user device 130. Client side application 160 operates in connection with contact management system 100 to implement various aspects of the invention. In some implementations of the invention, client side application 160 includes a client side contact database that stores contacts possessed by user 140 on user device 130. In some implementations of the invention, client side application 160 includes a reference to a server side contact database that stores contacts possessed by user 140 on a remote device as would be appreciated. In some implementations of the invention, client side application 160 replaces a local contact database on user device 130. In some implementations of the invention, client side application 160 works in connection with an existing local contact database on user device 130.

In some implementations of the invention, after user 140 enters or otherwise accesses a phone number via user device 130, client side application 160 prompts user 140 to provide one or more ratings for an entity associated with the phone number. In some implementations, client side application 160 forwards the phone number and the one or more ratings for the entity to a server side application 170. Server side application 170 receives the phone number and the one or more ratings from user device 130 and determines an updated social dynamic rating for the contact and the underlying entity.

In some implementations of the invention, client side application 160 scans user device 130 for phone numbers, either inbound or outbound, accessed by user device 130 and then prompts user 140 to provide one or more ratings for an entity associated with the phone number. In some implementations, client side application 160 forwards the phone number and the one or more ratings for the entity to a server side application 170. Server side application 170 receives the phone number and the one or more ratings from user device 130 and determines an updated social dynamic rating for the contact and the underlying entity.

In some implementations of the invention, client side application 160 scans user device 130 for phone numbers stored on user device 130 and then prompts user 140 to provide one or more ratings for an entity associated with the phone number. In some implementations, client side application 160 forwards the phone number and the one or more ratings for the entity to a server side application 170. Server side application 170 receives the phone number and the one or more ratings from user device 130 and determines an updated social dynamic rating for the contact and the underlying entity.

In some implementations of the invention, client side application 160 scans a local contacts database on user device 130 and prompts user 140 to provide one or more ratings for each contact in the local contacts database. In some implementations, client side application 160 forwards the contact and the one or more ratings for the entity to a server side application 170. Server side application 170 receives the contact and the one or more ratings from user device 130 and determines an updated social dynamic rating for the contact and the underlying entity.

In some implementations of the invention, the phone number may used to identify and access information in contact database 110 although other information may be used as would be apparent.

In some implementations of the invention, the updated social dynamic rating for the contact is provided to each of users 140 of contact management system 100. In some implementations of the invention, the updated social dynamic rating for the contact is provided to each of users 140 that possess the contact. In some implementations of the invention, the updated social dynamic rating for the contact is provided to each of users 140 that access the contact (e.g., by entering the phone number for the contact). In some implementations of the invention, the updated social dynamic rating for the contact is provided to each of users 140 that request information pertaining to the contact. In some implementations of the invention, the updated social dynamic rating for the contact is provided to each of users 140 that enters the contact into a local contact database on user device 130. In some implementations of the invention, the updated social dynamic rating for the contact is provided to each of the users 140 that possess some degree of relatedness to the user that provided the new rating.

In some implementations of the invention, one or more updated social dynamic ratings are provided to each user device 130 on a periodic basis. In some implementations of the invention, one or more updated social dynamic ratings are provided to each user device 130 as each user 140 accesses contact management system 100 via user device 130. In some implementations of the invention, one or more updated social dynamic rating are provided to each user device 130 as each user 140 synchronizes user device 130 with contact management system 100. In some implementations of the invention, an updated social dynamic rating is provided to a user device 130 in response to a request by user 140 for information pertaining to the contact.

While the description above references use of a phone number for accessing various aspects of invention, other identifying information may be used including, but not limited to a web address of the contact, an email address of the contact, a physical address of the contact, a name of the contact, a geo-code of the contact, a text message address of the contact, or other identifying information or combinations thereof.

In some implementations of the invention, an entity may access contact management system 100 to obtain their own social dynamic rating in an effort to understand how the entity is perceived by their users 140. In some implementations of the invention, an entity may access contact management system 100 to identify which users 140 possess the entity's contact. In some implementations of the invention, an entity may access contact management system 100 to identify which users 140 accessed the entity's contact. In some implementations of the invention, an entity may access contact management system 100 to identify which users 140 provided a rating for the entity's contact. In various implementations of the invention, the entity may use this understanding of users' 140 interaction with the entity's contact for various business purposes, including, but not limited to direct advertising, loyalty programs, incentive programs, and/or other business purposes.

In some implementations of the invention, incentives may be provided to users that provide ratings via the contact management system for a particular entity. The incentives may include a coupon. Other incentives may be provided. Different levels of incentives may be provided based on an amount of ratings or other information provided by the user. For example, greater incentives may be provided based on a level of detail provided by the user in rating the entity associated with the contact.

In some implementations of the invention, incentives may be provided to users that refer other users to the contact management system or that refer a particular contact to other users.

In some implementations of the invention, an entity may publish information pertinent to or descriptive of the entity. In some implementations of the invention, this information may be accessible via a mobile device. In some implementations of the invention, this information may include an incentive that may be delivered to the mobile device of the user via, for example, an SMS, email, link, or other communication. In some implementations of the invention, the incentive may be delivered to the user after the user provides a rating of the entity.

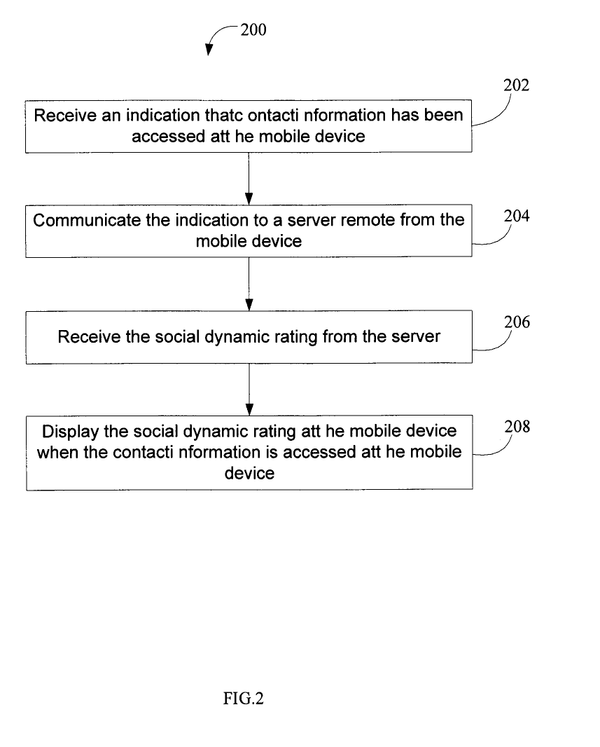

FIG. 2 illustrates an exemplary process 200 of social dynamic ratings displayed at a mobile device according to various implementations of the invention. The various processing operations and/or data flows depicted in FIG. 2 (and in the other drawing figures) are described in greater detail herein. The described operations for a flow diagram may be accomplished using some or all of the system components described in detail above and, in some implementations, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In an operation 202, process 200 may receive an indication that contact information has been accessed at a mobile device (such as, for example, user device 130 illustrated in FIG. 1), wherein the contact information is associated with an entity. For example, an application executing at the mobile device may scan for incoming or outgoing phone calls, may track a frequency (i.e., number of instances) in which contact information is accessed, and/or perform other actions that may be used to indicate an access of the contact information.

In an operation 204, process 200 may communicate the indication to a server remote from the mobile device, wherein the server generates a social dynamic rating of the entity based at least in part on the indication. For example, the application executing at the mobile device may communicate the indication to the remote server. The remote server may use the indication to generate a social dynamic rating for the entity. In the above examples, the social dynamic rating may be based on the frequency in which contact information for the entity is accessed.

In an operation 206, process 200 may receive the social dynamic rating from the server. In some implementations of the invention, the social dynamic rating may be stored locally at the mobile device. For example, the application executing at the mobile device may receive the social dynamic rating from the server and may store the social dynamic rating in a memory of the mobile device for retrieval.

In an operation 208, process 200 may display the social dynamic rating at the mobile device when the contact information is accessed at the mobile device. For example, the application executing at the mobile device may cause the mobile device to display the social dynamic rating with the contact information when the contact information is displayed. As would be appreciated, the contact information may be displayed when a user of the mobile device accesses the contact information such as by viewing contacts, calling a contact, emailing a contact, or otherwise viewing or interacting with the contact information.

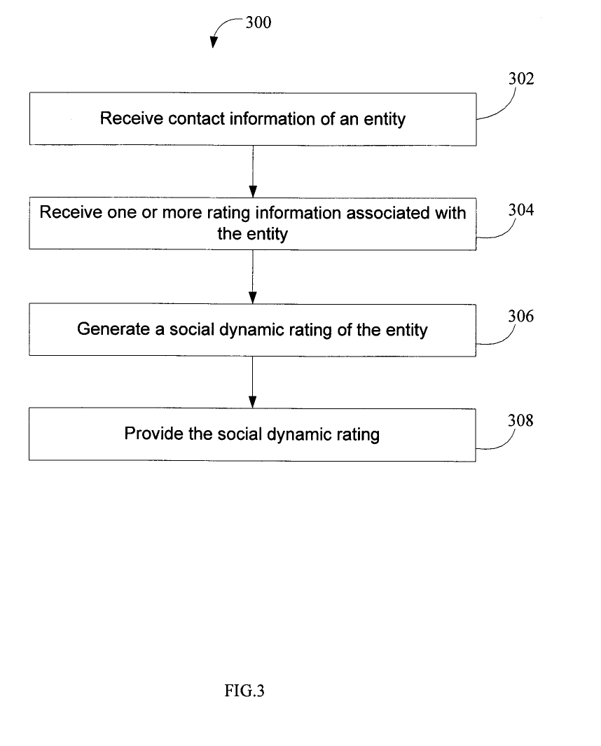

FIG. 3 illustrates an exemplary process 300 of generating social dynamic ratings according to various implementations of the invention.

In an operation 302, process 300 may receive contact information of an entity, wherein the contact information is provided by a mobile device from among a plurality of contacts stored at the mobile device. The contact information may include, for example, a phone number, an email address, mailing address, and/or other information that may be used to identify or otherwise describe an entity.

In an operation 304, process 300 may receive one or more rating information associated with the entity. In some implementations of the invention, the rating information may include, for example, a frequency in which a contact is accessed at the mobile device, an explicit rating of the entity provided by a user, meta-information (such as text, photos, and/or other information) that describes the entity, and/or other information that may be used when generating or displaying a social dynamic rating of the entity.

In an operation 306, process 300 may generate a social dynamic rating of the entity, wherein the social dynamic rating comprises an assessment of the entity and is based on at least a portion of the one or more rating information. In other words, process 300 may receive a plurality of rating information, some or all of which may be used to generate the social dynamic rating of the entity. For example, in some implementations, only rating information from users related to the user of the mobile device may be used to generate the social dynamic rating. Users may be related to the user of the mobile device by sharing a common contact, being included in the contacts of the user, explicitly being included as a relationship (such as an indication that another user/contact is a friend, family member, etc.), and/or other having another relationship. In this manner, social dynamic ratings for entities may in some implementations be more relevant to a user than, for example, a rating from the general public.

In operation 308, process 300 may provide the social dynamic rating to the mobile device or a user interface remote from the mobile device. In other words, once the social dynamic rating is generated, process 300 may provide the rating to a user interface that displays the social dynamic rating. In some implementations of the invention, the social dynamic rating is provided to the mobile device. In some implementations of the invention, the social dynamic rating is provided to an interface remote from the mobile device.

Various implementations of the invention may be embodied upon tangible computer readable storage media storing instructions that when executed on a processor cause the processor to perform various operations described herein. Such computer readable storage media may include, for example, a floppy disk, a compact disk, a digital video disk, a read-only memory, a random access memory, or other computer memory, and/or other tangible storage media. In some implementations, the computer readable storage media may reside at a computing device such as a server that communicates the instructions to be executed at a remote device such as a mobile device or other computing device. In some implementations, the computer readable storage media may reside at a computing device such as a mobile device so that the computing device is preconfigured with the instructions.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of social dynamic ratings for contacts stored at a mobile device, comprising:
receiving an indication that contact information has been accessed at the mobile device, wherein the contact information is associated with an entity;
communicating the indication to a server remote from the mobile device, wherein the server generates a social dynamic rating of the entity based at least in part on the indication;
receiving the social dynamic rating from the server; and
displaying the social dynamic rating at the mobile device when the contact information is accessed at the mobile device.

2. The computer-implemented method of claim 1, wherein the social dynamic rating is based on one or more indications each provided by a plurality of mobile devices that share a relationship with the mobile device.

3. The computer-implemented method of claim 2, wherein the relationship comprises the mobile device storing information for the plurality of mobile devices among the plurality of contacts.

4. The computer-implemented method of claim 2, wherein the relationship comprises a sharing of at least one contact between the mobile device and at least one of the plurality of mobile devices.

5. The computer-implemented method of claim 2, wherein the relationship comprises an explicit relationship indicated by the mobile device and at least one of the plurality of mobile devices.

6. The computer-implemented method of claim 1, further comprising:
receiving mobile device information associated with the mobile device; and
ordering the display of the contact information and the social dynamic rating based on the mobile device information.

7. The computer-implemented method of claim 6, wherein the mobile device information comprises a location of the mobile device, and wherein the contact information is displayed according to a location of the entity associated with the contact information.

8. The computer-implemented method of claim 1, further comprising:
in response to the indication, prompting for entity information associated with the entity;
receiving the entity information; and
communicating the entity information to the server.

9. The computer-implemented method of claim 1, wherein the indication comprises a frequency with which the contact information is accessed at the mobile device.

10. The computer implemented method of claim 1, wherein the indication indicates an inbound or outbound communication between the mobile device and another communication device identified by the contact information has occurred.

11. The computer implemented method of claim 1, wherein the indication indicates the contact information has been displayed from among a plurality of contacts stored at the mobile device.

12. The computer implemented method of claim 1, wherein receiving an indication further comprises interrogating the mobile device to determine whether the contact information has been accessed.

13. The computer implemented method of claim 1, further comprising:
receiving, from the server, a social dynamic rating for the entity; and
displaying the social dynamic rating when the contact information is accessed at the mobile device.

14. A computer readable storage medium storing instructions thereon, the instructions when executed by one or more processors cause the processor to:
receive an indication that contact information has been accessed at the mobile device, wherein the contact information is associated with an entity;
communicate the indication to a server remote from the mobile device, wherein the server generates a social dynamic rating of the entity based at least in part on the indication;
receive the social dynamic rating from the server; and
display the social dynamic rating at the mobile device when the contact information is accessed at the mobile device.

15. The computer readable storage medium of claim 14, wherein the social dynamic rating is based on one or more indications each provided by a plurality of mobile devices that share a relationship with the mobile device.

16. The computer readable storage medium of claim 15, wherein the relationship comprises the mobile device storing information for the plurality of mobile devices among the plurality of contacts.

17. The computer readable storage medium of claim 15, wherein the relationship comprises a sharing of at least one contact between the mobile device and at least one of the plurality of mobile devices.

18. The computer readable storage medium of claim 15, wherein the relationship comprises an explicit relationship indicated by the mobile device and at least one of the plurality of mobile devices.

19. The computer readable storage medium of claim 14, the instructions further causing the one or more processors to:
receive mobile device information associated with the mobile device; and
order the display of the contact information and the social dynamic rating based on the mobile device information.

20. The computer readable storage medium of claim 19, wherein the mobile device information comprises a location of the mobile device, and wherein the contact information is displayed according to a location of the entity associated with the contact information.

21. The computer readable storage medium of claim 14, the instructions further causing the one or more processors to:
in response to the indication, prompt for entity information associated with the entity;
receive the entity information; and
communicate the entity information to the server.

22. The computer readable storage medium of claim 14, wherein the indication comprises a frequency with which the contact information is accessed at the mobile device.

23. The computer readable storage medium of claim 14, wherein the indication indicates an inbound or outbound communication between the mobile device and another communication device identified by the contact information has occurred.

24. The computer readable storage medium of claim 14, wherein the indication indicates the contact information has been displayed from among a plurality of contacts stored at the mobile device.

25. The computer readable storage medium of claim 14, wherein said receive an indication further comprises interrogate the mobile device to determine whether the contact information has been accessed.

26. The computer readable storage medium of claim 14, the instructions further causing the one or more processors to:
receive, from the server, a social dynamic rating for the entity; and
display the social dynamic rating when the contact information is accessed at the mobile device.

27. A computer-implemented method of providing social dynamic ratings for contacts stored at mobile devices, comprising:
receiving contact information of an entity, wherein the contact information is provided by a mobile device from among a plurality of contacts stored at the mobile device;
receiving one or more rating information associated with the entity;
generating a social dynamic rating of the entity, wherein the social dynamic rating comprises an assessment of the entity and is based on at least a portion of the one or more rating information; and
providing the social dynamic rating to the mobile device or a user interface remote from the mobile device.

28. The computer-implemented method of claim 27, wherein the rating information comprises a frequency of access of the contact information at the mobile device, wherein the social dynamic rating is based at least in part on the frequency of access.

29. The computer-implemented method of claim 27, wherein the rating information comprises at least one rating of the entity by a user.

30. The computer-implemented method of claim 27, wherein the at least a portion of the one or more rating information is a subset of the one or more rating information.

31. The computer-implemented method of claim 30, wherein the subset is based on rating information from one or more mobile devices that share a relationship with the mobile device.

32. The computer-implemented method of claim 31, wherein the relationship comprises the mobile device storing information for the one or more mobile devices among the plurality of contacts.

33. The computer-implemented method of claim 31, wherein the relationship comprises a sharing of at least one contact between the mobile device and the one or more mobile devices.

34. The computer-implemented method of claim 31, wherein the relationship comprises an explicit relationship indicated by the mobile device or the one or more mobile devices.

35. The computer-implemented method of claim 27, further comprising:
applying a weighting factor that adjusts the social dynamic rating; and
providing the weighted social dynamic rating.

36. The computer-implemented method of claim 35, further comprising:
receiving an indication of a time since a particular contact was accessed at the mobile device, wherein the weighting factor is based on the indication of the time and is applied to a particular rating by a particular user associated with the particular contact.

37. The computer-implemented method of claim 35, further comprising:
receiving an indication of a reliability of a particular user, wherein the weighting factor is based on the reliability and is applied to a particular rating by the particular user.

38. The computer-implemented method of claim 35, further comprising:
receiving an indication of a frequency of use of a particular contact, the frequency of use indicating a frequency with which the particular contact is accessed at the mobile device, wherein the weighting factor is based on the frequency of use and is applied to a particular rating by a particular user associated with the particular contact.

39. The computer-implemented method of claim 27, further comprising:
receiving at least one additional rating information associated with the entity;
generating an updated social dynamic rating based on the at least a portion of the one or more rating information and the at least one additional rating information; and
providing the updated social dynamic rating to the mobile device.

40. A system of providing social dynamic ratings for contacts stored at mobile devices, comprising:
one or processors configured to:
receive contact information of an entity, wherein the contact information is provided by a mobile device from among a plurality of contacts stored at the mobile device;
receive one or more rating information associated with the entity;
generate a social dynamic rating of the entity, wherein the social dynamic rating comprises an assessment of the entity and is based on at least a portion of the one or more rating information; and
provide the social dynamic rating to the mobile device or a user interface remote from the mobile device.

41. The system of claim 40, wherein the rating information comprises a frequency of access of the contact information at the mobile device, wherein the social dynamic rating is based at least in part on the frequency of access.

42. The system of claim 40, wherein the rating information comprises at least one rating of the entity by a user.

43. The system of claim 40, wherein the at least a portion of the one or more rating information is a subset of the one or more rating information.

44. The system of claim 43, wherein the subset is based on rating information from one or more mobile devices that share a relationship with the mobile device.

45. The system of claim 44, wherein the relationship comprises the mobile device storing information for the one or more mobile devices among the plurality of contacts.

46. The system of claim 44, wherein the relationship comprises a sharing of at least one contact between the mobile device and the one or more mobile devices.

47. The system of claim 44, wherein the relationship comprises an explicit relationship indicated by the mobile device or the one or more mobile devices.

48. The system of claim 40, the one or more processors further configured to:
apply a weighting factor that adjusts the social dynamic rating; and
provide the weighted social dynamic rating.

49. The system of claim 48, the one or more processors further configured to:
receive an indication of a time since a particular contact was accessed at the mobile device, wherein the weighting factor is based on the indication of the time and is applied to a particular rating by a particular user associated with the particular contact.

50. The system of claim 48, the one or more processors further configured to:
receive an indication of a reliability of a particular user, wherein the weighting factor is based on the reliability and is applied to a particular rating by the particular user.

51. The system of claim 48, the one or more processors further configured to:
receive an indication of a frequency of use of a particular contact, the frequency of use indicating a frequency with which the particular contact is accessed at the mobile device, wherein the weighting factor is based on the frequency of use and is applied to a particular rating by a particular user associated with the particular contact.

52. The system of claim 40, the one or more processors further configured to:
receive at least one additional rating information associated with the entity;
generate an updated social dynamic rating based on the at least a portion of the one or more rating information and the at least one additional rating information; and
provide the updated social dynamic rating to the mobile device.
